(19) United States
(12) Patent Application Publication
(10) Pub. No.: US 2004/0027937 A1
(43) Pub. Date: Feb. 12, 2004

(54) Focus servo compensation apparatus and method using a tracking error signal of an optical disc

(75) Inventor: Moon Soo Han, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/413,139

(22) Filed: Apr. 15, 2003

(30) Foreign Application Priority Data
Aug. 9, 2002 (KR) 2002-47209

(51) Int. Cl. G11B 7/095

(52) U.S. Cl. 369/44.29

(57) ABSTRACT

A focus servo compensation apparatus of a pickup reads information from an optical disc and outputs signals indicative thereof. The focus servo compensation apparatus includes an RF processing unit receiving the output signals from the pickup and generating therefrom tracking error (TE) and focus error (FE) signals, a tracking servo, and a focus servo. A system controller of the focus servo compensation apparatus receives the TE and RF signals, turns off the tracking servo, and, while the focus servo is on, determines an initial compensation value for the focus servo based on an average value of the TE signals by applying a predetermined bias adjustment value to an output of the focus servo. When the tracking servo is turned on, the system controller controls a compensation of the focus servo by applying the determined initial compensation value to the focus servo.

### CROSS-REFERENCE TO RELATED APPLICATIONS

This application claims the priority of Korean Patent Application No. 2002-47209, filed on Aug. 9, 2002, in the Korean Intellectual Property Office, the disclosure of which is incorporated herein in its entirety by reference.

### BACKGROUND OF THE INVENTION

1. Field of the Invention

The present invention relates to an apparatus and method for operating an optical recording medium, and more particularly, to an apparatus and method for compensating for a focus servo using a tracking error signal of an optical disc.

2. Description of the Related Art

As optical discs are becoming more and more popular, manufacturers thereof introduce various types of optical discs. Every optical disc contains specific information for that optical disc and has unique characteristics concerning servo operations to reproduce the optical disc. A servo system to reproduce the optical disc typically follows a compensation method as shown in FIG. 1.

When the optical disc to be reproduced is inserted (OPERATION 100) in a disc player (not shown), the type of optical disc and coefficient values adequate to reproduce the optical disc are determined (OPERATION 101). After the type of optical disc has been determined, an optical pickup (not shown) performs focusing operations with respect to the optical disc, and a focus servo loop enters an on mode (OPERATION 102). At this instant, a tracking servo automatically enters an off mode (OPERATION 103). While the tracking servo is in the off mode (OPERATION 103), compensation of the tracking servo is carried out (OPERATION 104), and then, the tracking servo loop enters the on mode (OPERATION 105). While the tracking servo loop is in the on mode, compensation for a focus servo is carried out (OPERATION 106). Thereafter, a gain of the entire system loop is adjusted (OPERATION 107), and then the optical disc is reproduced (OPERATION 108). Deviation of the optical disc and the pickup are compensated through the operations described above.

Briefly, in order to compensate for the deviation of the optical disc and the pickup, the tracking servo and the focus servo of the focus servo loop need to be compensated. The compensation for the tracking servo is carried out while the tracking servo is off and the focus servo is on. On the other hand, the compensation for the focus servo is carried out while the tracking and focus servos are on. Generally, the compensation for the focus servo is carried out using a so called focus bias adjustment in which a constant voltage value is added to or subtracted from an output signal of the focus servo so that an adequate signal for the optical disc can be provided, or through an automatic tilt adjustment. If a focus bias adjusted value is not substantially different from an initial value, the focus servo stably operates while the tracking servo is off. However, if there is a significant difference between the focus bias adjusted value and the initial value, operations of the focus servo are unstable while the tracking servo is off.

In general, if the focus bias is optimum, a signal reflected by the pickup can have a maximum value, and accordingly, focus error (FE) and tracking error (TE) signals to be produced using the reflected signal can have optimum signal qualities. In a case of the optical disc having a significant difference between the focus bias adjusted value and the initial value, the focus servo loop enters the on mode while the initial value is zero (OPERATION 102). However, because the focus servo becomes unstable when the tracking servo enters the off mode, turning on the tracking servo thereafter may occasionally fail. Accordingly, a problem occurs where it is not possible to reproduce the optical disc that could have been reproduced by merely adding or subtracting a normal bias adjustment value to and from the output signal of the focus servo.

### SUMMARY OF THE INVENTION

According to an aspect of the present invention, there is provided a focus servo compensation apparatus using a tracking error signal of an optical disc, which compensates for a focus servo while a tracking servo loop is off so that the tracking servo loop can be operated stably in an on mode to reproduce the optical disc.

Further, according to an aspect of the present invention, there is provided a focus servo compensation method using a tracking error signal of an optical disc, which compensates for a focus servo while a tracking servo loop is off so that the tracking servo loop can be operated stably in an on mode to reproduce the optical disc.

According to an aspect of the present invention, a focus servo compensation apparatus is provided, which includes a servo loop including a pickup reading signals from an optical disc, an RF processing unit receiving output signals of the pickup and providing tracking error (TE) and focus error (FE) signals, a servo control unit receiving the TE and FE signals from the RF processing unit and providing a servo control signal to control a tracking servo or a focus servo, and a motor driving unit moving a position of the pickup in response to the servo control signal from the servo control unit; and a controlling unit determining an initial compensation value of the focus servo based on an average value of the TE signals from the RF processing unit by applying a predetermined focus bias adjustment value to an output of the focus servo while the tracking servo is off, and compensating the focus servo by applying the initial compensation value to the focus servo when the tracking servo is turned on.

In the focus servo compensation apparatus, according to an aspect of the present invention, the controlling unit includes a calculating unit calculating average values of the TE signals from the RF processing unit for a predetermined period of time by applying first, second, and third focus bias adjustment values to an output of the focus servo, and a selecting unit selecting a focus bias adjustment value corresponding to a highest value of the calculated average values of the TE signals.

In the focus servo compensation apparatus, according to an aspect of the first, second, and third bias adjustment values comprise an initial value, a focus bias adjustment value to be added to the output of the focus servo, and a focus bias adjustment value to be subtracted from the output of the focus servo, respectively.

In the focus servo compensation apparatus, according to an aspect of the present invention, the calculating unit calculates the average values using peak-to-peak values of the TE signals from the RF processing unit.

In addition, according to an aspect of the present invention, there is provided a focus servo compensation method of a servo loop including a pickup to read signals from an optical disc, an RF processing unit to receive output signals of the pickup and to provide tracking error (TE) and focus error (FE) signals, a servo control unit to receive the TE and FE signals from the RF processing unit and to provide a servo control signal to control a tracking servo or a focus servo, and a motor driving unit to move a position of the pickup in response to the servo control signal from the servo control unit, the method including: compensating the tracking servo while the focus servo is on and the tracking servo is off; determining an initial compensation value of the focus servo after compensating the tracking servo while the tracking servo is off; and compensating the focus servo using the initial compensation value when the tracking servo is turned on.

In the focus servo compensation method, according to an aspect of the present invention, the determining of the initial compensation value includes: applying first, second, and third focus bias adjustment values to an output of the focus servo, calculating average values of the TE signals provided from the RF processing unit for a predetermined period of time, and selecting a focus bias adjustment value corresponding to a highest value of the calculated average values of the TE signals.

In step (b-1) of the focus servo compensation method, according to an aspect of the present invention, the first, second, and third bias adjustment values include an initial value, a focus bias adjustment value to be added to the output of the focus servo, and a focus bias adjustment value to be subtracted from the output of the focus servo, respectively.

Further, the applying of the first, second, and third focus bias adjustment values and the calculation of the average values of the TE signals include: calculating the average values using peak-to-peak values of the TE signals from the RF processing unit.

According to an aspect of the present invention, there is provided a focus servo compensation apparatus of a pickup reads information from an optical disc and outputs signals indicative thereof, the focus servo compensation apparatus including: an RF processing unit receiving the output signals from the pickup and generating therefrom tracking error (TE) and focus error (FE) signals; a tracking servo; a focus servo; and a system controller receiving the TE and RF signals, turning off the tracking servo, and while the focus servo is on, determining an initial compensation value for the focus servo based on an average value of the TE signals by applying a predetermined bias adjustment value to an output of the focus servo, wherein, when the tracking servo is turned on, the system controller controls a compensation of the focus servo by applying the determined initial compensation value to the focus servo.

According to an aspect of the present invention, there is provided a focus servo compensation method of a servo loop including a pickup, an RF processing unit generating tracking error (TE) and focus error (FE) signals, a focus servo, a tracking servo, and a system controller, including: determining a type of optical disc; turning on the focus servo; turning off the tracking servo; setting a first focus bias adjustment value as an initial bias adjustment value for the focus servo; calculating an average value of TEₚₚ1 peak-to-peak values of the TE signals for a first predetermined period of time; setting a second focus bias adjustment value as the first focus bias adjustment value, which is added to an output of the focus servo; calculating an average value TEₚₚ2 of the peak-to-peak values of the TE signals for a second predetermined period of time; setting a third focus bias adjustment value as the second focus bias adjustment value, which is subtracted from the output of the focus servo; calculating an average value TEₚₚ3 of the peak-to-peak values of the TE signals for a third predetermined period of time; and determining a focus bias adjustment value corresponding to a highest value among the values of TEₚₚ1, TEₚₚ2, and TEₚₚ3, and using the determined focus bias adjustment value as the initial compensation value for the focus servo.

These together with other aspects and/or advantages which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

The above aspects and/or advantages of the present invention will become more apparent by describing preferred aspects thereof with reference to the attached drawings in which:

FIG. 1 is a flowchart of a conventional servo compensation method;

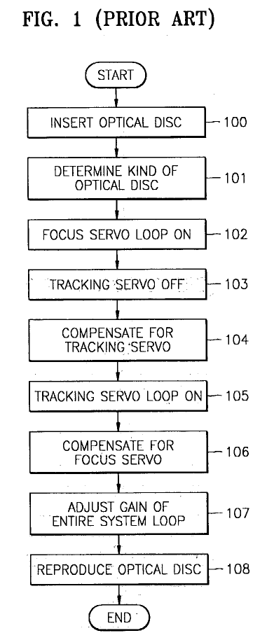

FIG. 2 is a block diagram of a focus servo compensation apparatus, according to an aspect of the present invention;

FIG. 3 is a flowchart of a focus servo compensation method, according to an aspect of the present invention; and

FIG. 4 is a detailed flowchart of determining an initial compensation value for the focus servo using the method shown in FIG. 3.

### DETAILED DESCRIPTION OF THE PREFERRED EMBODIMENTS

Hereinafter, aspects of the present invention will be described in detail with reference to the attached drawings. The present invention may, however, be embodied in many different forms and should not be construed as being limited to the aspects set forth herein; rather, these aspects are provided so that the present disclosure will be thorough and complete, and will fully convey the concept of the invention to those skilled in the art.

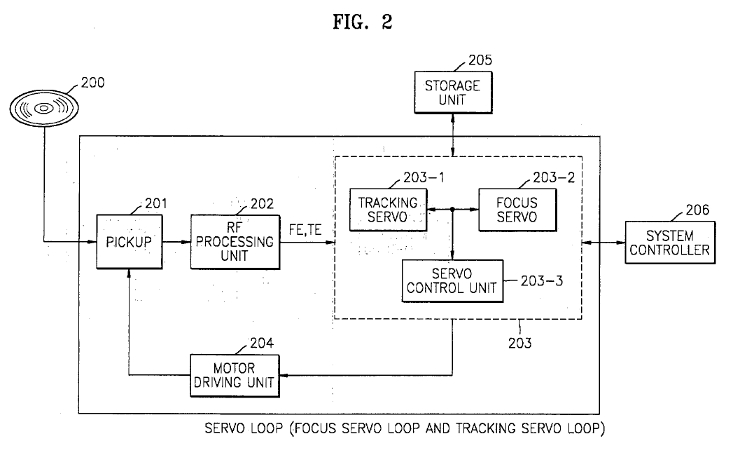

Referring to FIG. 2, a focus servo compensation apparatus, according to an aspect of the present invention, includes an optical disc 200, a pickup 201, an RF processing unit 202, a motor driving unit 204, a storage unit 205, a system controller 206, and a servo adjusting unit 203 including a tracking servo 203-1, a focus servo 203-2, and servo control unit 203-3. In this aspect, the pickup 201, the RF processing unit 202, the servo adjusting unit 203, and the motor driving unit 204 configure a servo loop, i.e., a focus servo loop and a tracking servo loop.

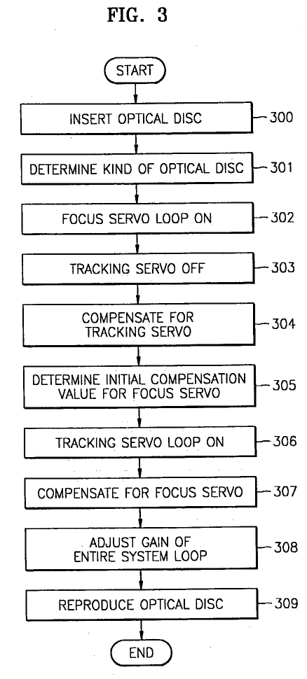

Referring to FIG. 3, a focus servo compensation method, according to an aspect of the present invention, includes inserting the optical disc 200 (OPERATION 300) in a disc player, determining a type of optical disc (OPERATION 301), turning on the focus servo loop (OPERATION 302), turning off the tracking servo loop (OPERATION 303), compensating for the tracking servo (OPERATION 304), determining an initial compensation value for the focus servo 203-2 (OPERATION 305), turning on the tracking servo loop (OPERATION 306), compensating for the focus servo 203-2 (OPERATION 307), adjusting a loop gain of the entire apparatus (OPERATION 308), and reproducing the optical disc 200 (OPERATION 309).

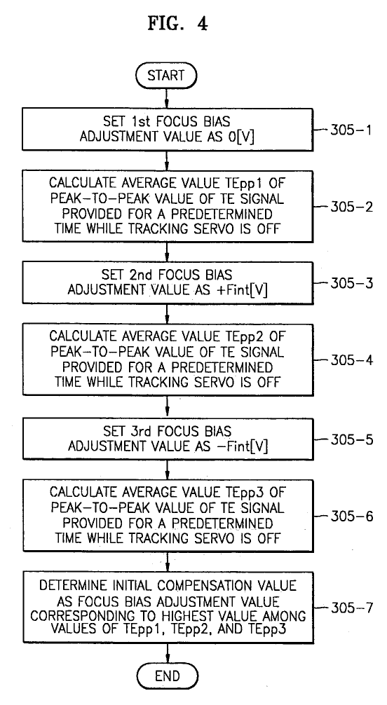

FIG. 4 is a detailed flowchart of determining the initial compensation value for the focus servo 203-2 using the method shown in FIG. 3. Referring to FIG. 4, the determining of the initial compensation value for the focus servo 203-2 includes setting a first focus bias adjustment value as 0 V (OPERATION 305-1), calculating an average value TEₚₚ1 of peak-to-peak values of tracking error (TE) signals provided for a first predetermined period of time while the tracking servo 203-1 is off (OPERATION 305-2), setting a second focus bias adjustment value as +Fᵢₙₜ V (OPERATION 305-3), calculating an average value TEₚₚ2 of the peak-to-peak values of the TE signals provided for a second predetermined period of time while the tracking servo is off (OPERATION 305-4), setting a third focus bias adjustment value as −Fᵢₙₜ V (OPERATION 305-5), calculating an average value TEₚₚ3 of the peak-to-peak values of the TE signals provided for a third predetermined period of time while the tracking servo is off (OPERATION 305-6), and determining a focus bias adjustment value corresponding to a highest value among the values of TEₚₚ1, TEₚₚ2, and TEₚₚ3, and using the determined focus bias adjustment value as the initial compensation value for the focus servo 203-2 (OPERATION 305-7).

The focus servo compensation apparatus and method, according to an aspect of the present invention, will be described below, in greater detail, with reference to FIGS. 2 to 4.

Referring again to FIG. 2, the focus servo loop follows an accurate focus position of the pickup 201 when recording or reproducing the optical disc 200 by adjusting gains of the RF processing unit 202, the servo adjusting unit 203, and the motor driving unit 204. Meanwhile, the tracking servo loop follows an accurate tracking position of the pickup 201 on the optical disc 200 by adjusting gains of the RF processing unit 202, the servo adjusting unit 203, and the motor driving unit 204.

The RF processing unit 202 amplifies RF signals transmitted from the pickup 201 to predetermined values, and produces focus error (FE) and tracking error (TE) signals using the amplified RF signals. Producing the FE and TE signals from the RF signals is carried out using a well-known method. Then, the produced FE and TE signals are transmitted to the servo control unit 203-3.

When the optical disc 200 is inserted in the disc player, the system controller 206 detects the type of optical disc 200 and determines coefficient values adequate for reproducing the optical disc 200. The system controller 206 controls the overall apparatus.

The system controller 206 controls the servo control unit 203-3 so that focusing of the pickup 201 with respect to the optical disc 200 can be achieved. When the focusing of the pickup 201 with respect to the optical disc 200 is achieved, the system controller 206 is provided with an instruction to enable the servo control unit 203-3 to control the tracking servo 203-1 and the focus servo 203-2. The system controller 206 turns off the tracking servo 203-1, and while the tracking servo 203-1 is off, determines an initial compensation value for the focus servo 203-2 based on an average value of the TE signals from the RF processing unit 202 by applying a predetermined bias adjustment value to an output of the focus servo 203-2. Thereafter, when the tracking servo 203-1 is turned on, the system controller 206 controls the compensation of the focus servo 203-2 by applying the determined initial compensation value to the focus servo 203-2.

Although not shown in FIG. 2, the system controller 206 includes a calculating unit and a selecting unit. The calculating unit calculates the average values TEₚₚ1, TEₚₚ2, and TEₚₚ3 of the peak-to-peak signals of the TE signals from the RF processing unit 202 for the predetermined period of time by applying the first, second, and third focus bias adjustment values to the outputs of the focus servo 203-2. The first focus bias adjustment value is an initial bias adjustment value, i.e., 0 V, the second focus bias adjustment value is a focus bias adjustment value to be added to the output of the focus servo, i.e., +Fᵢₙₜ V, and the third focus bias adjustment value is a focus bias adjustment value to be subtracted from the output of the focus servo, i.e., −Fᵢₙₜ V. The calculated average values TEₚₚ1, TEₚₚ2, and TEₚₚ3 together with the first, second, and third focus bias adjustment values are stored in the storage unit 205. The selecting unit selects the focus bias adjustment value corresponding to the highest value from the calculated average values TEₚₚ1, TEₚₚ2, and TEₚₚ3 of the TE signals. The selected focus bias adjustment value is determined as the initial compensation value for the focus servo 203-2.

Under the control of the system controller 206, the servo control unit 203-3 receives the initial compensation value, and compensates for the focus servo 203-2 with the initial compensation value when the tracking servo 203-1 is turned on. The motor driving unit 205 relocates the pickup 201 based on the compensation values for the tracking servo 203-1 and the focus servo 203-2 from the servo adjustment unit 203.

Now, the focus servo compensation method, according to an aspect of the present invention, will be described in more detail with reference to FIGS. 3 and 4.

The optical disc 200 is inserted for the reproduction thereof (OPERATION 300) in the disc player. When the optical disc 200 is inserted in the disc player, the system controller determines the type of optical disc 200 and the coefficient values adequate for the optical disc 200 (OPERATION 301). After determining the type of optical disc 200, the system controller 206 controls the servo control unit 203-3 to adjust the location of the pickup 201 so that the focusing of the pickup 201, with respect to the optical disc 200, is made and enables the focus servo loop to enter an on mode (OPERATION 302). The focus servo loop includes a closed loop with the RF processing unit 202, the servo adjusting unit 203, and the motor driving unit 204 to follow an accurate focusing location of the pickup 201 with respect to the optical disc 200.

When the focus servo loop enters the on mode, and the focus servo 203-2 is turned on, the servo control unit 203-3 turns off the tracking servo 203-1 under the control of the system controller 206 (OPERATION 303). While the tracking servo 203-1 is off, the servo control unit 203-1 compensates for the tracking servo 203-1 (OPERATION 304). The compensation for the tracking servo 203-1 is performed through a well-known compensation method.

Further, while the tracking servo 203-1 is off, the system controller 206 determines the initial compensation value for the focus servo 203-2 (OPERATION 305). FIG. 4 shows a method of determining the initial compensation value for the focus servo 203-2.

The system controller 206 sets the first focus bias adjustment value as an initial bias adjustment value for the focus servo 203-2, i.e., 0 V (OPERATION 305-1). When the first focus bias adjustment value is set, the system controller 206 calculates an average value of TEₚₚ1 peak-to-peak values of the tracking error (TE) signals from the RF processing unit 202 for a predetermined period of time while the tracking servo 203-1 is off (OPERATION 305-2). The calculated average value TEₚₚ1 is stored in the storage unit 205 together with the first focus bias adjustment value.

Thereafter, the system controller 206 sets the second focus bias adjustment value as a focus bias adjustment value to be added to the output of the focus servo 203-1, i.e., +Fᵢₙₜ V (OPERATION 305-3). When the second focus bias adjustment value is set, the system controller 206 calculates an average value TEₚₚ2 of the peak-to-peak values of the TE signals from the RF processing unit 202 for a predetermined period of time while the tracking servo is off (OPERATION 305-4). The calculated average value TEₚₚ2 is stored in the storage unit 205 together with the second focus bias adjustment value.

Thereafter, the system controller 206 sets the third focus bias adjustment value as a focus bias adjustment value to be added to the output of the focus servo 203-2, i.e., −Fᵢₙₜ V (OPERATION 305-5). When the third focus bias adjustment value is set, the system controller 206 calculates an average value TEₚₚ3 of the peak-to-peak values of the TE signals from the RF processing unit 202 for a predetermined period of time while the tracking servo is off (STEP 305-6). The calculated average value TEₚₚ3 is stored in the storage unit 205 together with the second focus bias adjustment value.

Then, the system controller 206 determines the focus bias adjustment value corresponding to the highest value among the values of TEₚₚ1, TEₚₚ2, and TEₚₚ3, and using the determined focus bias adjustment value as the initial compensation value for focus servo 203-2 (OPERATION 305-7).

After determining the initial compensation value for the focus servo 203-2, the servo control unit 203-3 enables the tracking servo loop to enter the on mode under the control of the system controller 206 (OPERATION 306). Because the peak-to-peak signal of the TE signal, from the RF processing unit 202 while the tracking servo 203-1 is off, can be maximum when the focus bias is optimum, the tracking servo 203-1 is now turned on with a new initial value adequate for the optical disc 200 rather than the existing focus bias initial value of 0 V. The tracking servo loop includes the closed loop with the RF processing unit 202, the servo adjusting unit 203, and the motor driving unit 204 to follow an accurate tracking location of the pickup 201 with respect to the optical disc 200.

While the tracking servo loop is on, the servo control unit 203-3 receives the initial compensation value for the focus servo 203-2 determined by the system controller 206, and compensates for the focus servo 203-2 (OPERATION 307). After adjusting the gain of the entire system loop (OPERATION 308), the optical disc 200 is reproduced (OPERATION 309). Through the operations as described above, deviation of the optical disc 200 and the pickup 201 can be compensated.

According to an aspect of the present invention, it is possible to compensate for a focus servo while a tracking servo loop is off, and stably operate a tracking servo loop in an on mode to reproduce an optical disc. Therefore, information can be efficiently reproduced from the optical disc and transferred to users.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A focus servo compensation method of a servo loop comprising a pickup to read signals from an optical disc, an RF processing unit to receive output signals of the pickup and to provide tracking error (TE) and focus error (FE) signals, a servo control unit to receive the TE and FE signals from the RF processing unit and to provide a servo control signal to control a tracking servo or a focus servo, and a motor driving unit to move a position of the pickup in response to the servo control signal from the servo control unit, the method comprising:
compensating the tracking servo while the focus servo is on and the tracking servo is off;
determining an initial compensation value of the focus servo after compensating the tracking servo while the tracking servo is off; and
compensating the focus servo using the initial compensation value when the tracking servo is turned on.

2. The focus servo compensation method according to claim 1, wherein the determining of the initial compensation value comprises:
applying first, second, and third focus bias adjustment values to an output of the focus servo,
calculating average values of the TE signals provided from the RF processing unit for a predetermined period of time, and
selecting a focus bias adjustment value corresponding to a highest value of the calculated average values of the TE signals.

3. The focus servo compensation method according to claim 2, wherein the first, second, and third bias adjustment values comprise an initial value, a focus bias adjustment value to be added to the output of the focus servo, and a focus bias adjustment value to be subtracted from the output of the focus servo, respectively.

4. The focus servo compensation method according to claim 3, wherein the applying of the first, second, and third focus bias adjustment values and the calculation of the average values of the TE signals comprise:
calculating the average values using peak-to-peak values of the TE signals from the RF processing unit.

5. A focus servo compensation apparatus reading signals from an optical disc, comprising:
a servo loop comprising
a pickup reading the signals from the optical disc,
an RF processing unit receiving output signals of the pickup and providing tracking error (TE) and focus error (FE) signals,
a servo control unit receiving the TE and FE signals from the RF processing unit and providing a servo control signal to control a tracking servo or a focus servo, and
a motor driving unit moving a position of the pickup in response to the servo control signal from the servo control unit; and
a controlling unit determining an initial compensation value of the focus servo based on an average value of the TE signals from the RF processing unit by applying a predetermined focus bias adjustment value to an output of the focus servo while the tracking servo is off, and compensating the focus servo by applying the initial compensation value to the focus servo when the tracking servo is turned on.

6. The focus servo compensation apparatus according to claim 5, wherein the controlling unit comprises
a calculating unit calculating average values of the TE signals from the RF processing unit for a predetermined period of time by applying first, second, and third focus bias adjustment values to an output of the focus servo, and
a selecting unit selecting a focus bias adjustment value corresponding to a highest value of the calculated average values of the TE signals.

7. The focus servo compensation apparatus according to claim 6, wherein the first, second, and third bias adjustment values comprise an initial value, a focus bias adjustment value to be added to the output of the focus servo, and a focus bias adjustment value to be subtracted from the output of the focus servo, respectively.

8. The focus servo compensation apparatus according to claim 6, wherein the calculating unit calculates the average values using peak-to-peak values of the TE signals from the RF processing unit.

9. A focus servo compensation apparatus of a pickup reading information from an optical disc and outputs signals indicative thereof, the focus servo compensation apparatus comprising:
an RF processing unit receiving the output signals from the pickup and generating therefrom tracking error (TE) and focus error (FE) signals;
a tracking servo;
a focus servo; and
a system controller receiving the TE and RF signals, turning off the tracking servo, and, while the focus servo is on, determining an initial compensation value for the focus servo based on an average value of the TE signal by applying a predetermined bias adjustment value to an output of the focus servo, wherein, when the tracking servo is turned on, the system controller controls a compensation of the focus servo by applying the determined initial compensation value to the focus servo.

10. The focus servo compensation apparatus according to claim 9, wherein the system controller calculates average values TEₚₚ1, TEpp2, and TEₚₚ3 of peak-to-peak signals of the TE signals provided from the RF processing unit for a predetermined period of time by applying first, second, and third focus bias adjustment values to the outputs of the focus servo.

11. The focus servo compensation apparatus according to claim 10, wherein the first focus bias adjustment value is an initial bias adjustment value comprising 0 volts, the second focus bias adjustment value is a first focus bias adjustment value to be added to the output of the focus servo comprising +Fᵢₙₜ volts, and the third focus bias adjustment value is a second focus bias adjustment value to be subtracted from the output of the focus servo comprising −Fᵢₙₜ volts.

12. The focus servo compensation apparatus according to claim 11, wherein the storage unit stores the calculated average values TEₚₚ1, TEₚₚ2, and TEₚₚ3 and the first, second, and third focus bias adjustment values.

13. The focus servo compensation apparatus according to claim 10, wherein the system controller selects the focus bias adjustment value corresponding to a highest value from the calculated average values TEₚₚ1, TEₚₚ2, and TEₚₚ3 of the TE signals, where the selected focus bias adjustment value is determined as the initial compensation value for the focus servo.

14. The focus servo compensation apparatus according to claim 9, wherein the system controller receives the initial compensation value, and compensates for the focus servo with the initial compensation value when the tracking servo is turned on.

15. The focus servo compensation apparatus according to claim 9, further comprising:
a motor driving unit adjusting a focus position of the pickup based on the initial compensation value.

16. The focus servo compensation apparatus according to claim 9, wherein the RF processing unit amplifies RF signals transmitted from the pickup to predetermined values, and produces the FE and TE signals using the amplified RF signals.

17. A focus servo compensation method of a servo loop having a pickup reading signals from an optical disc, an RF processing unit generating tracking error (TE) and focus error (FE) signals, a focus servo, a tracking servo, and a system controller, the method comprising:
determining a type of the optical disc;
turning on the focus servo;
turning off the tracking servo;
setting a first focus bias adjustment value as an initial bias adjustment value for the focus servo;
calculating an average value of TEₚₚ1 peak-to-peak values of the TE signals for a first predetermined period of time;
setting a second focus bias adjustment value as the first focus bias adjustment value, which is added to an output of the focus servo;
calculating an average value TEₚₚ2 of the peak-to-peak values of the TE signals for a second predetermined period of time;
setting a third focus bias adjustment value as the second focus bias adjustment value, which is subtracted from the output of the focus servo;
calculating an average value TEₚₚ3 of the peak-to-peak values of the TE signals for a third predetermined period of time; and
determining a focus bias adjustment value corresponding to a highest value among the values of TEₚₚ1, TEₚₚ2, and TEₚₚ3, and using the determined focus bias adjustment value as the initial compensation value for the focus servo.

18. The focus servo compensation method according to claim 17, wherein the first focus bias adjustment value is the initial bias adjustment value comprising 0 volts, the second focus bias adjustment value is the first focus bias adjustment value to be added to the output of the focus servo comprising +Fᵢₙₜ volts, and the third focus bias adjustment value is the second focus bias adjustment value to be subtracted from the output of the focus servo comprising −Fᵢₙₜ volts.

19. The focus servo compensation method according to claim 17, further comprising:
storing the calculated average values TEₚₚ1, TEₚₚ2, and TEₚₚ3 and the first, second, and third focus bias adjustment values.
